(19) United States
(12) Patent Application Publication
(10) Pub. No.: US 2020/0378780 A1
(43) Pub. Date: Dec. 3, 2020

(54) METHOD AND APPARATUS FOR PROVIDING AN INTERMODAL ROUTE ISOLINE MAP

(71) Applicant: HERE GLOBAL B.V., Eindhoven (NL)

(72) Inventors: Jerome BEAUREPAIRE, Berlin (DE); Jens UNGER, Berlin (DE)

(21) Appl. No.: 16/424,016

(22) Filed: May 28, 2019

(51) Int. Cl. G01C 21/36; G06Q 10/04

(52) U.S. Cl. CPC G01C 21/367; G06Q 10/047; G01C 21/3697

(57) ABSTRACT

An approach is provided for providing an intermodal route isoline map. A routing platform determines real-time availability data of a plurality of modes of transport within a geographic area. The routing platform further computes an isoline based on the real-time availability data, wherein the isoline represents a geographic extent that is reachable from a starting location within a designated travel time using an intermodal route that combines at least two of the plurality of modes of transport. The routing platform further provides data to generate a user interface depicting a representation of the isoline in the intermodal route isoline map.

### BACKGROUND

Service providers and automobile manufacturers are continually challenged to deliver value and convenience to consumers by, for example, providing compelling navigation services. One area of interest has been the development of intermodal routing services that provide routes combining different routing modes for car, pedestrian and public transit. However, as the numbers of intermodal transport options (e.g., shared vehicles and their providers) increase in many cities around the world, service providers face significant technical challenges associated with visualizing available intermodal routes and conveying how they might benefit a user's journey.

### SOME EXAMPLE EMBODIMENTS

Therefore, there is a need for an approach for providing an intermodal route isoline map that visualizes reachable areas via intermodal routing.

According to one embodiment, a method comprises determining real-time availability data of a plurality of modes of transport within a geographic area. The method also comprises computing an isoline based on the real-time availability data, wherein the isoline represents a geographic extent that is reachable from a starting location within a designated travel time using an intermodal route that combines at least two of the plurality of modes of transport. The method further comprises providing data to generate a user interface depicting a representation of the isoline in the intermodal route isoline map.

According to another embodiment, an apparatus comprises at least one processor, and at least one memory including computer program code for one or more computer programs, the at least one memory and the computer program code configured to, with the at least one processor, determine real-time availability data of a plurality of modes of transport within a geographic area. The apparatus is also caused to compute an isoline based on the real-time availability data, wherein the isoline represents a geographic extent that is reachable from a starting location within a designated travel time using an intermodal route that combines at least two of the plurality of modes of transport. The apparatus is further caused to provide data to generate a user interface depicting a representation of the isoline in the intermodal route isoline map.

According to another embodiment, a computer-readable storage medium carries one or more sequences of one or more instructions which, when executed by one or more processors, cause, at least in part, an apparatus to determine real-time availability data of a plurality of modes of transport within a geographic area. The apparatus is also caused to compute an isoline based on the real-time availability data, wherein the isoline represents a geographic extent that is reachable from a starting location within a designated travel time using an intermodal route that combines at least two of the plurality of modes of transport. The apparatus is further caused to provide data to generate a user interface depicting a representation of the isoline in the intermodal route isoline map.

According to another embodiment, an apparatus comprises means for determining real-time availability data of a plurality of modes of transport within a geographic area. The apparatus also comprises means for computing an isoline based on the real-time availability data, wherein the isoline represents a geographic extent that is reachable from a starting location within a designated travel time using an intermodal route that combines at least two of the plurality of modes of transport. The apparatus further comprises means for providing data to generate a user interface depicting a representation of the isoline in the intermodal route isoline map.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system for providing an intermodal route isoline map, according to one embodiment;

FIG. 1B is a diagram of a transportation database, according to one embodiment;

FIG. 2 is a diagram of the components of a routing platform, according to one embodiment;

FIG. 3 is a diagram of a user interface used in the processes for isoline routing a user, according to one embodiment;

FIG. 4 is a flowchart of a process for providing an intermodal route isoline map, according to one embodiment;

FIGS. 5A-5E are diagrams of user interfaces used in the processes for providing an intermodal route isoline map, according to various embodiments;

FIGS. 6A-6B are diagrams of user interfaces used in the processes for providing an mobility provider service area isoline map, according to various embodiments;

FIG. 7 is a diagram of a user interface used in the processes for providing an intermodal route isoline map with a restricted area, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., mobile computer) that can be used to implement an embodiment of the invention.

### DESCRIPTION OF SOME EMBODIMENTS

Examples of a method, apparatus, and computer program for providing an intermodal route isoline map are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

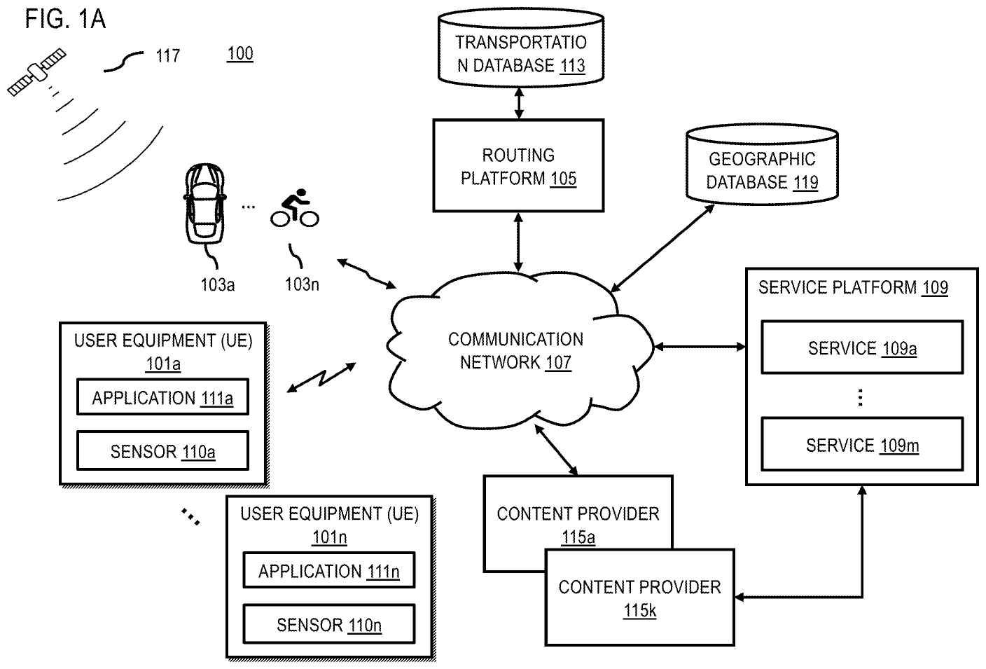

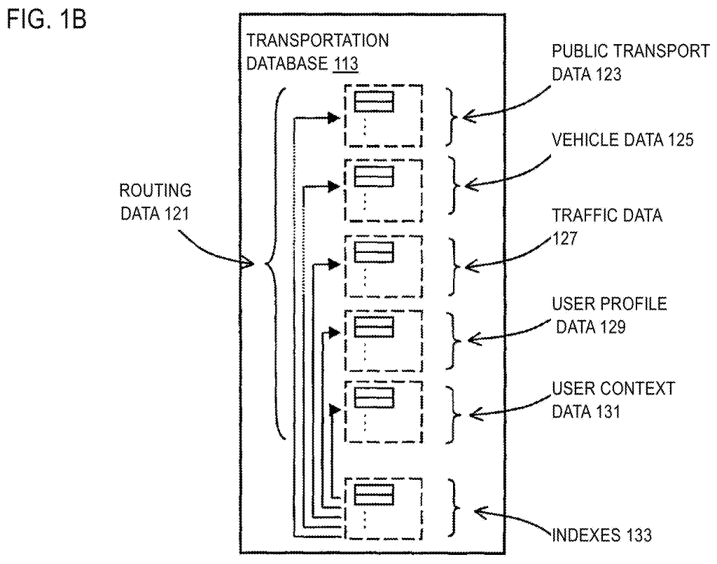

FIG. 1A is a diagram of a system for providing an intermodal route isoline map, according to one embodiment. As discussed above, visualizing available intermodal routes on one user interface to show reachable areas via intermodal routing (e.g., public, private or shared autonomous vehicles, etc.) is technically challenging. One approach to showing reachable areas is the use of an isoline the represent a distance that can be reached from a starting location within a period of time (e.g., 15 mins, 30 mins, etc.). Generating isolines for traditional modes of transportation (e.g., user-owned vehicles, public transport, etc.) can be relatively straightforward because factors such as a vehicle availability, locations, etc. are generally available. However, when applied to intermodal routes using more transient modes of transport such as shared vehicles (e.g., shared bicycles, shared scooters, shared cars, etc.), determining isolines can be much more technically challenging. This is because the locations, availability, service areas, range, etc. of shared vehicles can be very volatile, and can therefore make knowing what transport options are available and when much more complex and difficult. In addition, the large numbers of available shared vehicles and/or corresponding providers of the shared vehicles (e.g., mobility providers) within a given area can also make visualizing the best options among the available options difficult.

To address this problem, a system 100 of FIG. 1A introduces a capability to show a spatial representation of reachable areas when combining several modes of transport, especially with shared vehicles. In one embodiment, the system 100 optimizes a user's travel time (or route or other routing cost function parameter such as distance, fuel efficiency, etc.) to a destination by considering all possible modes of transport (e.g., public transport buses, trains, shared vehicles, etc.). In particular, the system 100 computes and visualizes intermodal isolines by making real-time computations of all possible combinations of available vehicle combinations. In one embodiment, the system 100 uses a probabilistic approach to predict the availability of shared vehicles and other modes of transport, and then to calculate the reachable extent using the shared vehicles that are predicted to be available when a user is predicted to reach the shared vehicle's location (e.g., parked location, travel hub, service area, etc.). In other words, a key question answered by the system 100 for a user according to one embodiment is: “Being at my current location, what is the opportunity map for me right now of all the places I can reach within, e.g., 30 minutes or any other designated time, considering all available real-time data about transport modes and available shared vehicles?” In one embodiment, the system 100 responds to this question by presenting or providing data for presenting a user interface depicting one or more isolines representing the reachable extent or opportunity provided by an intermodal route using real-time availability and/or probabilistic availability of shared vehicles.

By way of example, the system 100 uses two-dimensional isoline routing, dynamic (or real time) traffic monitoring and timing adjustments to identify optimal intermodal routes to a destination. Optimal, for instance, refers to riding locations that enable the user and/or a respective vehicle to reach a destination of the route with a time, distance, etc. that meets threshold requirements or is a minimum among calculated candidate routes and/or locations.

In one embodiment, the system 100 can determine transport availability information (e.g., either the availability of transport modes or the unavailability of transport modes) based on static transport schedule data, and/or real-time transport tracking data. By way of example, the transport modes may include a public transit mode, a pedestrian mode, a bicycling mode, a shared vehicle, etc. A shared vehicle may be a car, a motorcycle, an electric bike, an electric scooter, a bicycle, a boat, etc. owned by an individual, a commercial business, a public agency, a cooperative, or an ad hoc grouping. In another embodiment, the system 100 optimizes the intermodal isolines computations through probabilistic approaches (e.g., by predicting the available of shared vehicles that can affect the reachable extent that can be traveled by a user within the time represented by the isoline). Availability of shared vehicles can also be customized based on the mobility providers preferred by a user or for which the user has an account, and/or based on any other selecting criteria or setting.

The vehicle (e.g., cars, motorcycles, electric bikes, electric scooters, bicycles, boats, airplanes, etc.) can be human-operated, semi-autonomous, or autonomous. In one embodiment, the user owns an autonomous vehicle which operates autonomously to a riding point of a route calculated according to the embodiments to meet up with the user and travel to the final destination of the route. In another embodiment, the user owns a human-operated or semi-autonomous vehicle and finds another driver (e.g., a contact or a stranger) to operate the vehicle to a riding point, to either handover the vehicle to the user or to continue riding together with the user to a destination. In another embodiment, the human-operated or semi-autonomous vehicle is owned by a business entity, a public entity, a stranger, or a contact of the user, and the contact or stranger agrees to operate the vehicle to a riding point, to either handover the vehicle to the user or to continue riding together with the user to a destination. These embodiments are applicable to a driverless taxi, centralized ride-sharing, peer-to-peer ride-sharing, car-pooling, taxi cabs, food delivery, etc.

In one embodiment, to avoid cluttering the use interface, the system 100 selectively presents to the user the intermodal routes, the isolines and the intermodal route isoline map based on user interactions. For example, in many cases, multiple shared vehicles can be available to a user to complete an intermodal journey. Rendering all of the available options in a user interface can overwhelm a user, make it difficult for a user to identify a specific shared vehicle that is to be taken and its effect on the reachable extent, etc. As a result, the system 100 can enable a user to select specific shared vehicles, mobility providers, etc. The system can then compute and render the reachable extent isolines based on the user's selection. For instance, in an example use case, an intermodal route can direct a user to take a subway to a riding location, then take a shared vehicle to a destination. In one example, the intermodal route comprises a subway segment and a shared vehicle segment, and the system 100 presents isolines originated from a selected subway station, and one or more sets of isolines originated from corresponding one or more candidate shared vehicles that are reachable via the subway in an intermodal route isoline map, without cluttering the user interface.

In another example, the system 100 presents the isolines originated from the selected subway station, and isolines of one selected shared vehicle that expand at least one of isolines originated from the selected subway station, in an intermodal route isoline map.

In another example, the system 100 presents a destination, the isolines originated from the selected subway station, and one or more sets of isolines originated from corresponding one or more candidate shared vehicles that are reachable via the subway in an intermodal route isoline map and enclose the destination, without cluttering the user interface.

In another example, the system 100 presents a destination, the isolines originated from the selected subway station, and isolines of one selected shared vehicle that expand at least one of isolines originated from a selected subway station and enclose the destination, in an intermodal route isoline map.

In one example, the system 100 visualizes virtual extensions of a mobility provider's service areas by computing isolines at the borders of those service areas, which represent areas reachable by users within a given amount of time (e.g., 10, min, 20 min, 30 min, etc.) from the borders, using one or more modes of transport, such as cars, motorcycles, electric bikes, electric scooters, bicycles, boats, airplanes, etc. that are not operated by the mobility provider.

In another example, to conserve computation resources, the system 100 visualizes virtual extensions of a mobility provider's service areas by computing isolines only at selected exit points of those service areas (e.g., highway junctions, transport hubs, other points of interest, on-street parking locations, etc.), which are reachable by users within a given amount of time (e.g., 10 min) from the exit points, using one or more modes of transport that are not operated by the mobility provider. In another example, the system 100 clusters those exit points in a meaningful way in order to further reduce the computation needs.

In another example, the system 100 visualizes virtual extensions of a mobility provider's service areas considering one or more traffic restricted areas/zones where some or all types of vehicles are forbidden at certain times, or on certain days or dates, or a combination thereof. For examples, there are big road-closing events, such as constructions, marathons, parades, protests, weekend markets, severe weather conditions, traffic accidents, etc.

In one embodiment, the system 100 includes one or more processes for automatically determining if and where a user may need intermodal routing, and providing guidance to the user to reach the destination faster and/or cheaper according to the embodiments described herein. In one embodiment, the system 100 receives a user request for an intermodal route to a destination. In another embodiment, the system 100 detects a user travel pattern/habit and predicts the user's need for an intermodal route to a destination. In yet another embodiment, the system 100 detects the user's need for an intermodal route to a destination from an entry in the user's calendar, a social media event accepted or signed up by the user, an event in the user's massage (e.g., email, text message, instant message, SMS message, MMS message, etc.).

In one embodiment, UEs 101 of a user and sensors in a vehicle 103 are collecting and reporting data (e.g., location data) to the system 100 to support the determination and visualization of the intermodal route isoline map according to the embodiments described herein. In this way, for instance, vehicles 103a-103n and/or vehicle users can use the system for sharing trajectory data and receiving vehicle supply and demand information as well as contextual data (e.g., traffic, weather conditions, etc.) that can be used to dynamically update the intermodal route isoline map. With this data along with other data such as but not limited to public transport information, the system 100 (e.g., a routing platform 105) can compute candidate intermodal routes to a destination. In this way, the system 100 can more precisely present to the user an intermodal route isoline map. In one embodiment, the UEs 101 and the routing platform 105 have connectivity via a communication network 107.

In one embodiment, the vehicles 103a-103n are equipped with a device (e.g., the UE 101 or other accessory device) that records the vehicles' trajectory data (e.g., position, speed, etc.). In one embodiment, the UE 101 may be configured with one or more sensors 110a-110n (also collectively referred to as sensors 110) for determining the trajectory data (including parking locations). By way of example, the sensors 110 may include location sensors (e.g., GPS), accelerometers, compass sensors, gyroscopes, altimeters, etc.

In one embodiment, after a journey or the trajectory data is recorded (e.g., upon parking), the trajectory data is analyzed (e.g., by respective applications 111a-111n and/or the routing platform 105 for storage in, for instance, a transportation database 113 and/or a geographic database 119) to determine intermodal routes and to provide an intermodal route isoline map. In one embodiment, timestamp information indicating at which time and which location the vehicle was parked is recorded as a record in the transportation database 113. In one embodiment, the record is then transmitted or uploaded to the routing platform 105. In addition or alternatively, the raw trajectory data may be uploaded to the routing platform 105 to determine the record. In yet another embodiment, the record and/or trajectory data may be maintained at the UE 101 device for local processing to determine intermodal routes and to provide an intermodal route isoline map for transmission to the routing platform 105 and/or other vehicles/UEs 101 (e.g., when operating in a peer-to-peer network architecture).

In one embodiment, when the UE 101 requests optimal intermodal routes to meet the vehicle 103 at or near a riding point then riding to a destination, the routing platform 105 computes candidate intermodal routes that includes a segment for the user to travel from the user location to a riding location via first transport mode and a segment for a second transport mode (e.g., a shared vehicle) to travel from the riding location to the destination, based on data from the transportation database 113 and/or the geographic database 119. The first transport mode may include walking, cycling, motorbiking, taking one or more taxis, taking one or more buses, taking one or more trains, taking one or more subways, taking one or more ferries, taking one or more shared vehicles, or a combination thereof.

In one embodiment, the routing platform 105 computes a segment for the user to get to the riding point using the first transport mode, assuming there is no delay of the estimated arrival time. In another embodiment, the routing platform 105 computes a segment for the user to get to the riding point using the first transport mode, when detecting there is traffic and/or weather delay of the estimated arrival time.

In one embodiment, the routing platform 105 is configured to monitor the user and the vehicle in order to generate travel status information and to calculate a respective probability for the first transport mode and the second transport mode to reach the riding location with respect to an expected time or time frame. In addition, the routing platform 105 may present to the user a real-time status of the vehicle, an estimated or predicted status, and/or the probability of the vehicle to arrive at the riding point with respect to an expected time or time frame. The status information may also be associated with timestamp information, the respective probability, and/or other contextual information (including parking) to store in the transportation database 113.

In one embodiment, the routing platform 105 may present to the user information on points of interest, parking areas, road segments, and/or related information retrieved from the geographic database 119, while the user is traveling on the transport mode segment. In addition or alternatively, such information can be provided by the service platform 109, one or more services 109a-109m (also collectively referred to as services 109), one or more content providers 115a-115k (also collectively referred to as content providers 115), or a combination thereof. For example, the sources of the information may include map data, information inferred from data collected from participating vehicles, or a combination thereof.

In one embodiment, when a vehicle 103 requests instructions to find parking or stopping spot at or near the riding point, the routing platform 105 computes a route to the riding point, assuming there is not delay of the estimated arrival time. In another embodiment, the routing platform 105 computes a route to the riding point, when detecting there is traffic and/or weather delay of the estimated arrival time.

In one embodiment, the routing platform 105 updates optimal or recommended candidate intermodal routes and the intermodal route isoline map based on, for instance, timestamps, a number of transport modes available, and fluctuations in the amount of transport modes, etc. around the user location or position (e.g., a current location of the client UE 101), based on real-time transport data from the transportation database 113.

In one embodiment, vehicles 103 are equipped with a navigation device (e.g., a UE 101) that is capable of submitting to the routing platform 105 requests for routing the user and the vehicle and of guiding of the user and the vehicle respectively. In one embodiment, as the user and the vehicle follow the respective segments, the UE 101 (e.g., via a navigation application 111) and the vehicle 103 may iterate their locations with timestamps to the routing platform 105 in order to update the travel status in a real-time and/or substantially real-time manner while factoring in delay caused by traffic, weather, etc.

As shown in FIG. 1A, the routing platform 105 operates in connection with UEs 101 and vehicles 103 for providing an intermodal route isoline map. By way of example, the UEs 101 may be any mobile computer including, but not limited to, an in-vehicle navigation system, vehicle telemetry device or sensor, a personal navigation device (“PND”), a portable navigation device, a cellular telephone, a mobile phone, a personal digital assistant (“PDA”), a wearable device, a camera, a computer and/or other device that can perform navigation or location based functions, i.e., digital routing and map display. In some embodiments, it is contemplated that mobile computer can refer to a combination of devices such as a cellular telephone that is interfaced with an on-board navigation system of an autonomous vehicle or physically connected to the vehicle for serving as the navigation system. Also, the UEs 101 may be configured to access a communication network 107 by way of any known or still developing communication protocols. Via this communication network 107, the UE 101 may transmit probe data as well as access various network based services for facilitating providing an intermodal route isoline map.

Also, the UEs 101 may be configured with navigation applications 111 for interacting with one or more content providers 115, services of the service platform 109, or a combination thereof. Per these services, the navigation applications 111 of the UE 101 may acquire routing instructions, transport mode information, traffic information, mapping information and other data associated with the current locations of the user and the vehicle, etc. Hence, the content providers 115 and service platform 109 rely upon the gathering of user, vehicle, and transport modes trajectory data and routing data for executing the aforementioned services.

The UEs 101 and the vehicles 103 may be configured with various sensors 110 for acquiring and/or generating trajectory data regarding the user, a vehicle, other vehicles, conditions regarding the driving environment or roadway, etc. For example, sensors 110 may be used as GPS receivers for interacting with one or more satellites 117 to determine and track the current speed, position and location of a user and/or a vehicle traveling along a roadway. In addition, the sensors 110 may gather tilt data (e.g., a degree of incline or decline of the vehicle during travel), motion data, light data, sound data, image data, weather data, temporal data and other data associated with UEs 101 and/or the vehicle 103 thereof. Still further, the sensors 110 may detect local or transient network and/or wireless signals, such as those transmitted by nearby devices during navigation of a vehicle along a roadway. This may include, for example, network routers configured within a premise (e.g., home or business), another UE 101 or vehicle 103 or a communicable traffic system (e.g., traffic lights, traffic cameras, traffic signals, digital signage). In one embodiment, the routing platform 105 aggregates probe data gathered and/or generated by the UEs 101 and/or the vehicle 103 resulting from the driving of multiple different vehicles over a road/travel network. The probe data may be aggregated by the routing platform 105 to providing an intermodal route isoline map.

By way of example, the routing platform 105 may be implemented as a cloud based service, hosted solution or the like for performing the above described functions. Alternatively, the routing platform 105 may be directly integrated for processing data generated and/or provided by service platform 109, content providers 115, and/or applications 111. Per this integration, the routing platform 105 may perform candidate routes calculation based on user/vehicle trajectory information and/or public transport information.

By way of example, the communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UEs 101, the vehicles 103, the routing platform 105, the service platform 109, and the content providers 115 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 1B is a diagram of the transportation database 113, according to one embodiment. In one embodiment, vehicle information and/or any other information used or generated by the system 100 with respect to providing an intermodal route isoline map based on routing data 121 stored in the transportation database 113, and associated with and/or linked to the geographic database 119 or data thereof.

In one embodiment, the routing data 121 include public transport data 123, vehicle data 125, traffic data 127, user profile data 129, user context data 131, indexes 133, etc. In one embodiment, the public transport data 123 can include any public transport data item used by the routing platform 105 including, but not limited to public transport type data, public transport schedule data, e.g., according to the General Transit Feed Specification (GTFS), public transport route and stop data, real-time public transport trajectory data, e.g., according to the GTFS real-time extensions, etc. retrieved from transit agencies, public transportation operators, etc. In one embodiment, the public transport data can be used in junction with the user profile data 129 and the user context data 131 to support the determination and visualization of the intermodal route isoline map. In another embodiment, the traffic data 127 is further included to support the determination and visualization of the intermodal route isoline map. The public transport data format may be in General Transit Feed Specification (GTFS), REST/XML, or other industry standards for publishing transportation network and schedule data. In one embodiment, the public transport include on-demand services (e.g., taxis, shared vehicles, etc.) and fixed-route services such as city buses, trolleybuses, trams (or light rail) and passenger trains, rapid transit (metro/subway/underground, etc.), ferries, airlines, coaches, intercity rail, etc.

In one embodiment, the vehicle data 125 can include any vehicle data item used by the routing platform 105 including, but not limited to vehicle type data, vehicle ownership data, vehicle route and stop data, real-time vehicle trajectory data, parking instance data, timestamp information for the parking instance data, etc. to support the determination and visualization of the intermodal route isoline map. In another embodiment, the traffic data 127 is further included to support the determination and visualization of the intermodal route isoline map.

In one embodiment, the traffic data 127 includes, but not limited to, travel speeds, congestions, detours, vehicle types and volumes, accidents, road conditions, road works, etc. on specific road segments.

In one embodiment, the user profile data 129 includes, but not limited to, the name, name, login named, screen named, nicknamed, handle names, home addresses, email addresses, government identification numbers, operator license/credential types (motorcycle, regular passenger vehicle, commercial vehicle, etc.), vehicle registration plate numbers, face, fingerprints, handwriting, credit card numbers, digital identities, date of birth, age, birthplace, genetic information (e.g., gender, race, etc.), telephone numbers, marriage status/records, criminal records, purchase records, financial data, activity records, employment records, insurance records, medical records, political and non-political affiliations, preferences (e.g., POIs), calendar data, driving history data, vehicle sharing data, etc. of the driver/requesting user.

In one embodiment, the user context data 131 includes, but not limited to, a destination of the requesting user, a type of the destination of the user, a proximity of the user location to a riding point or the destination, availability of an alternate destination for the user, a number of passengers accompanying the user, weather data in the vicinity of the user, etc.

More, fewer or different data records can be provided in the transportation database 113. One or more portions, components, areas, layers, features, text, and/or symbols of the routing data records in the transportation database 113 can be stored in, linked to, and/or associated with one or more of the data records of the geographic database 119 (such as mapping and/or navigation data).

In one embodiment, the geographic database 119 includes geographic data used for (or configured to be compiled to be used for mapping and/or navigation-related services, such as for route information, service information, estimated time of arrival information, location sharing information, speed sharing information, and/or geospatial information sharing, according to exemplary embodiments. For example, the geographic database 119 includes node data records, road segment or link data records, POI data records, parking availability data records, and other data records.

In exemplary embodiments, the road segment data records are links or segments representing roads, streets, or paths, as can be used in the calculated route or recorded route information. The node data records are end points corresponding to the respective links or segments of the road segment data records. The road link data records and the node data records represent a road network, such as used by vehicles, cars, and/or other entities. Alternatively, the geographic database 119 can contain path segment and node data records or other data that represent pedestrian paths or areas in addition to or instead of the vehicle road record data, for example.

The road link and nodes can be associated with attributes, such as geographic coordinates, street names, address ranges, speed limits, turn restrictions at intersections, and other navigation related attributes, as well as POIs, such as traffic controls (e.g., stoplights, stop signs, crossings, etc.), gasoline stations, hotels, restaurants, museums, stadiums, offices, automobile dealerships, auto repair shops, buildings, stores, parks, etc. The geographic database 119 can include data about the POIs and their respective locations in the POI data records. The geographic database 119 can also include data about places, such as cities, towns, or other communities, and other geographic features, such as bodies of water, mountain ranges, etc.

The transportation database 113 and/or the geographic database 119 can be maintained by the content provider in association with the service platform 109 (e.g., a map developer). The map developer can collect driving/parking data and geographic data to generate and enhance the transportation database 113 and/or the geographic database 119. There can be different ways used by the map developer to collect data. These ways can include obtaining data from other sources, such as municipalities or respective geographic authorities.

The transportation database 113 and/or the geographic database 119 can be stored in a format that facilitates updating, maintenance, and development of the relevant data. For example, the data in the transportation database 113 and/or the geographic database 119 can be stored in an Oracle spatial format or other spatial format. The Oracle spatial format can be compiled into a delivery format, such as a geographic data files (GDF) format to be compiled or further compiled to form geographic database products or databases, which can be used in end user navigation devices or systems.

As mentioned above, the transportation database 113 and the geographic database 119 are separated databases, but in alternate embodiments, the transportation database 113 and the geographic database 119 are combined into one database that can be used in or with end user devices (e.g., UEs 101) to provide navigation-related functions and provide shared vehicle information. For example, the databases 113, 119 are accessible to the UE 101 directly or via the routing platform 105. In another embodiments, the databases 113, 119 can be downloaded or stored on UE 101, such as in applications 111.

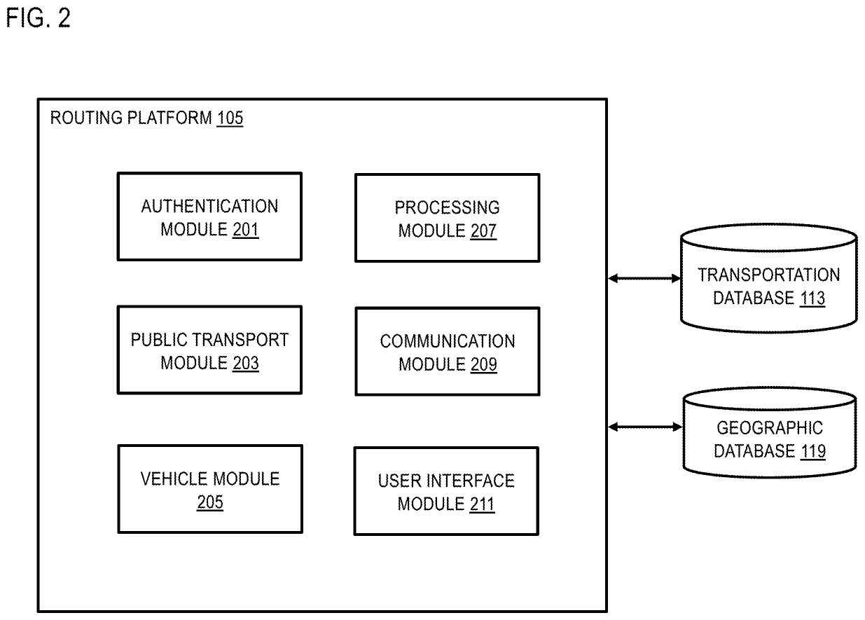

FIG. 2 is a diagram of the components of a routing platform, according to one embodiment. By way of example, the routing platform 105 includes one or more components for providing an intermodal route isoline map. It is contemplated that the functions of these components may be combined or performed by other components of equivalent functionality. In this embodiment, the routing platform 105 includes an authentication module 201, a public transport module 203, a vehicle module 205, a processing module 207, a communication module 209, and a user interface module 211.

In one embodiment, the authentication module 201 authenticates UEs 101 and/or associated vehicles 103 for interaction with the routing platform 105. By way of example, the authentication module 201 receives a request to access the routing platform 105 via an application 111. The request may be submitted to the authentication module 201 via the communication module 209, which enables an interface between the navigation application 111 and the platform 105. In addition, the authentication module 201 may provide and/or validate access by the UE 101 to upload trajectory data, and/or other location-based information to the platform 105. In one embodiment, the authentication module 201 may further be configured to support and/or validate the formation of profile by a provider of a service 109 or content provider 115, e.g., for supporting integration of the capabilities for providing an intermodal route isoline map with said providers 115 or services 109.

The public transport module 203 retrieves the public transport data 123 (including fixed-route and/or on-demand public transports and associated schedules and timestamps) from various sources such as the transportation database 113, transit agencies, public transportation operators, etc. In one embodiment, the public transport module 203 aggregates schedules of various public transport that are operated on fixed schedules. In another embodiment, the public transport module 203 analyzes trajectory data (including associated timestamps) uploaded by one or more authenticated public transport passenger UE 101 and/or various public transport to determine the status of the transports that operate on demand and/or the respective probability that the transports arrive at riding locations. In one embodiment, the public transport module 203 may receive other related data along with the trajectory data or segment lists such as acceleration, road curvature, vehicle tilt, driving mode, brake pressure, etc. It then stores the received data to database 113 optionally in association with a unique identifier of the various public transport that transmitted the trajectory data.

The vehicle module 205 collects and/or analyzes trajectory data (including associated timestamps) as generated by one or more authenticated UE 101 and one or more vehicles 103. For example, the vehicle module 205 aggregates the trajectory data of travel segments generated by the UE 101 and the one or more vehicles 103. In one embodiment, the vehicle module 205 may receive other related data along with the trajectory data or segment lists such as acceleration, road curvature, vehicle tilt, driving mode, brake pressure, etc. It then stores the received data to database 113 optionally in association with a unique identifier of the vehicle, driver of UE 101 that transmitted the trajectory data or lists.

In one embodiment, the processing module 207 computes a time-based isoline routing from a user location or from a riding location. In one embodiment, the processing module 207 uses the an isoline routing algorithm to request a polyline that connects the end points of all routes leaving from one defined center with either a specified length or a specified travel time.

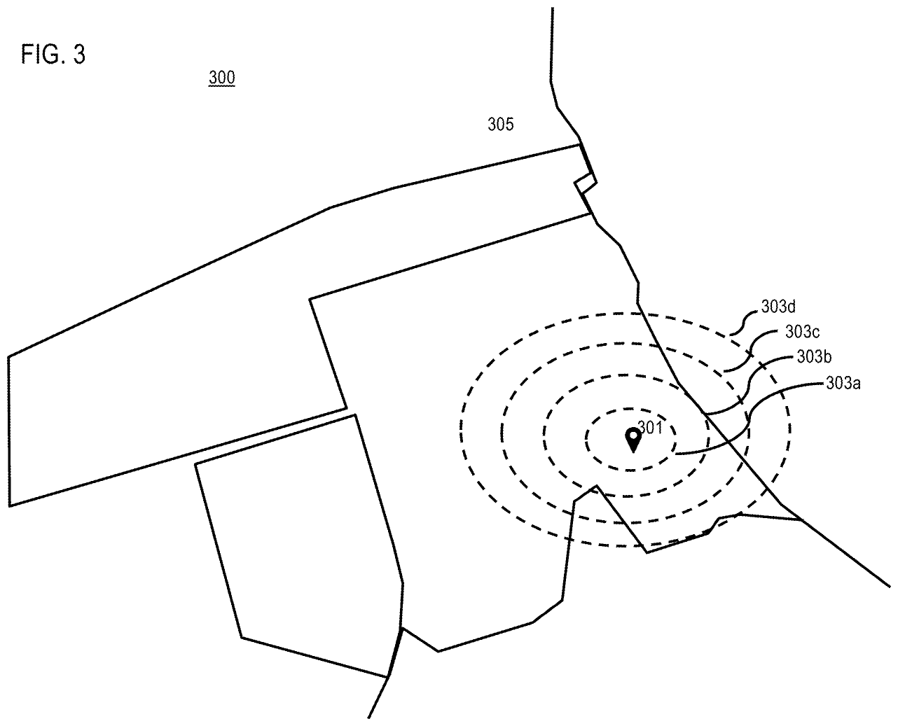

FIG. 3 is a diagram of a user interface used in the processes for isoline routing a user , according to one embodiment. For example, the processing module 207 calculates time-based isolines, specify time as rangetype and considering various transport modes. Range can be specified in seconds, minutes, hours, days, months, years, or other time segments. The user interface 300 shown in FIG. 3 depicts 10 minute isolines 303a, 303b, 303c, and 303d around a user location 301 and where can be reached in 10, 20, 30, 40 minutes from the center 301 by the user via, e.g., walking, in an area 305.

In one embodiment, the processing module 207 calculates intermodal routes, the isolines, and the intermodal route isoline map further based on one or more exclusion zones and/or scheduling information for the user. For example, the candidate intermodal routes and the isolines are calculated to avoid exclusion zones, such as electric vehicle only zones, no diesel zones, public transport only zones, parade routes, weekend pedestrian sidewalks, road work zones, etc. As another example, the processing module 207 factors in user' schedule including picking up a gift before riding the vehicle or picking up golf clubs after riding the vehicle, when calculating the candidate intermodal routes and the respective isolines.

In another embodiment, the processing module 207 determines one or more updated destinations of the user. For example, the user just receives a call from a friend requesting a pick up at an updated destination. The processing module 207 re-computes updated intermodal routes and isolines for the user using isoline routing based on the one or more updated destinations, and provides data for indicating updated isolines and intermodal route isoline map to the user.

In one embodiment, once the intermodal routes, the isolines, and the intermodal route isoline map are determined for all available transport modes, the processing module 207 can interact with the communication module 209 and/or the user interface module 211 to selectively present to the user the intermodal routes, the isolines and the intermodal route isoline map based on user interactions. By way of example, after the user selects a vehicle of a second transport mode in an initial intermodal route isoline map that includes isolines of all available vehicles of the first transport mode, the processing module 207 can interact with the communication module 209 and/or the user interface module 211 to present to the user either isolines of the selected vehicle or isolines of all available vehicles of the second transport mode in an updated intermodal route isoline map.

In another embodiment, the user further indicates a destination and is presented with only the intermodal routes to the destination. After the user selects a vehicle of a second transport mode in an initial intermodal route isoline map that includes isolines of the intermodal routes to the destination, the processing module 207 can interact with the communication module 209 and/or the user interface module 211 to present to the user either isolines of the selected vehicle or isolines of all available vehicles of the second transport mode in an updated intermodal route isoline map.

In one embodiment, the processing module 207 provides to the selected vehicle related navigation instructions, and/or other information determined for the selected vehicle to the destination. In another embodiment, the selected vehicle uses its own on board system the generate navigation instructions and/or other information for the vehicle, based on the candidate intermodal route, a respective riding location, and the destination.

Since there can be delays caused by traffic, weather, etc. for the user and/or the selected vehicle, the processing module 207 updates the user location, the selected vehicle location, or a combination thereof based on data from the transportation database 113 that is obtained via real-time monitoring by the system 100. In one embodiment, the processing module 207 updates the intermodal route isolines of the selected vehicle based on the updated user location and vehicle locations, and updates the riding location and the intermodal route isoline map using the updated isolines.

It is further noted that the user interface module 211 may operate in connection with the communication module 209 to facilitate the exchange of real-time location information and/or transport mode information via the communication network 107 with respect to the services 109, content providers 115 and applications 111. Alternatively, the communication module 209 may facilitate transmission of the real-time location information and/or the transport mode information directly to the services 109 or content providers 115.

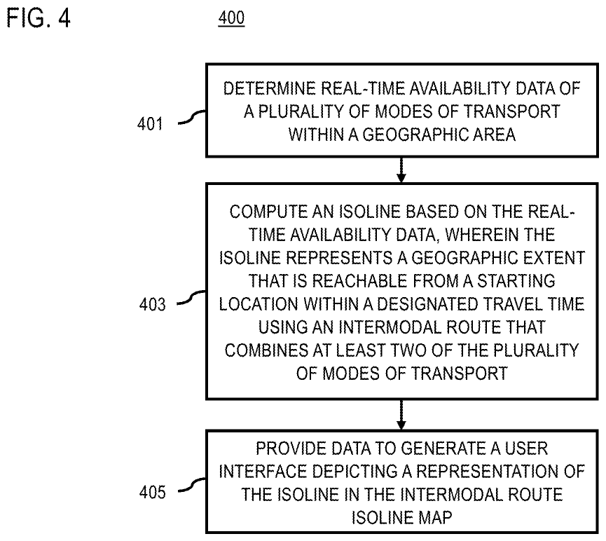

In other embodiments, the processing module 207 determines and presents intermodal routes and respective isolines in an intermodal route isoline map as described later in conjunction with FIGS. 4-7.

The above presented modules and components of the routing platform 105 can be implemented in hardware, firmware, software, or a combination thereof. Though depicted as a separate entity in FIG. 1A, it is contemplated that the platform 105 may be implemented for direct operation by respective UEs 101 and/or vehicles 103. As such, the routing platform 105 may generate direct signal inputs by way of the operating system of the UE 101 and/or vehicles 103 for interacting with the application 111. In another embodiment, one or more of the modules 201-211 may be implemented for operation by respective UEs 101 and/or vehicles 103a s a platform 105, cloud based service, or combination thereof.

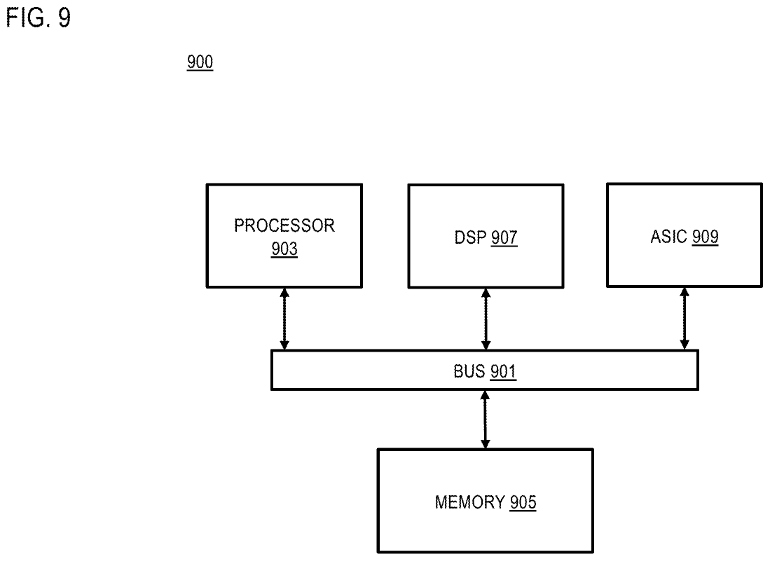

FIG. 4 is a flowchart of a process for providing an intermodal route isoline map, according to one embodiment. In one embodiment, the routing platform 105 performs the process 400 and is implemented in, for instance, a chip set including a processor and a memory as shown in FIG. 9. In addition or alternatively, all or a portion of the process 400 may be performed locally at the UE 101 and/or vehicle 103 (e.g., via the application 111 or another equivalent hardware and/or software component). The intermodal route isoline map may be a schematic or real size map.

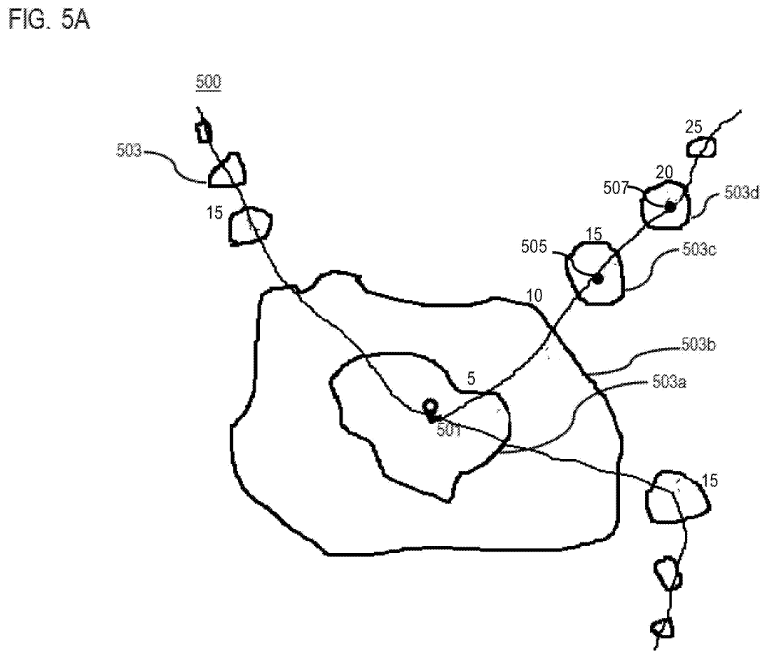

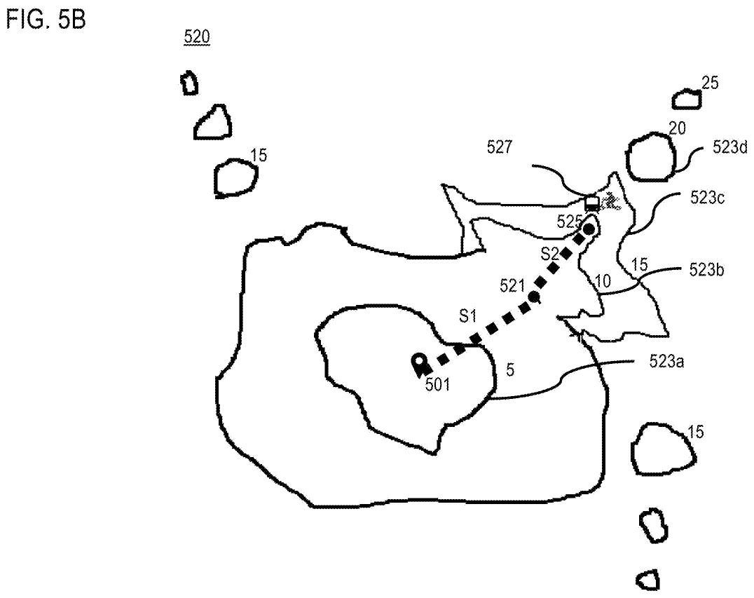

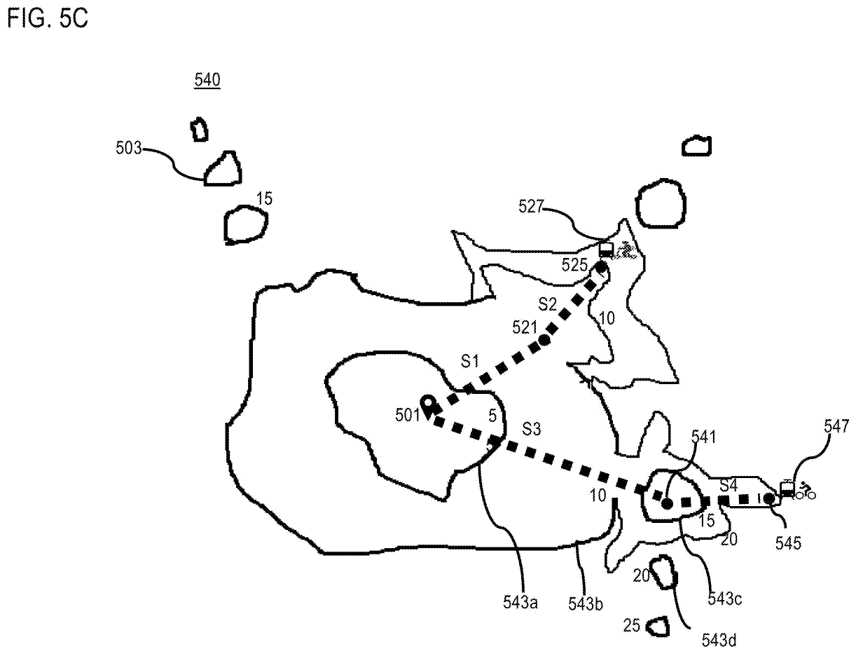

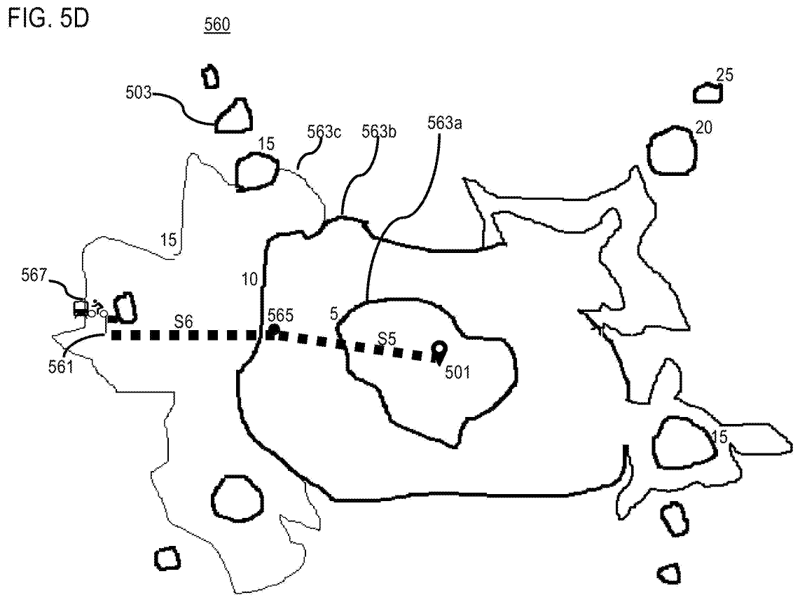

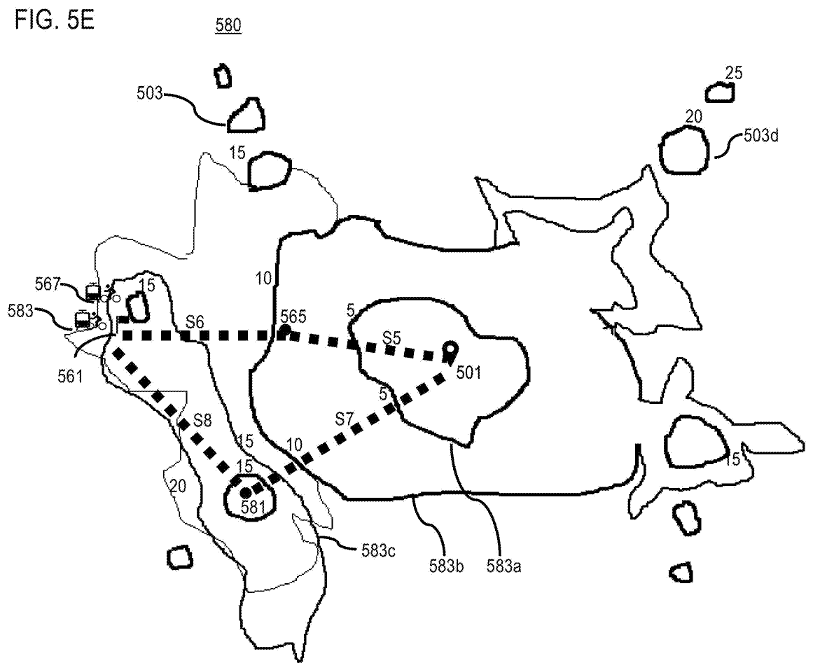

In step 401, the routing platform 105 determines real-time availability data of a plurality of modes of transport within a geographic area. By way of example, the real-time availability data includes at least one of: an availability of a shared vehicle (e.g., a car, motorcycles, electric bike, electric scooter, bicycle, boat, airplane, etc.), an operating area of a shared vehicle, public transport information, a mobility history of a user (e.g., user trajectory data), user preference information (e.g., extracted from the user profile data 129), user registration information with a mobility service (e.g., extracted from the user profile data 129), contextual information (e.g., extracted from the user context data 131), a user destination (e.g., based on an user input, extracted from the user context data 131, etc.), or a combination thereof. FIGS. 5A-5D are diagrams of user interfaces used in the processes for providing an intermodal route isoline map, according to various embodiments. More specifically, FIGS. 5A-5D illustrate user interfaces that can be used in real-time by UEs 101 participating in a routing service provided by the system 100.

In step 403, the routing platform 105 computes an isoline based on the real-time availability data. In one embodiment, the routing platform 105 computes a plurality of combinations of the at least two of the plurality of modes of transport (e.g., a subway plus one of a car, motorcycle, electric bike, electric scooter, bicycle, etc.).

In one embodiment, the routing platform 105 computes an initial set of isolines based on an selected initial vehicle or mode of transport (e.g., subway), wherein the initial set of isolines indicates a geographic extent that is reachable using the subway within designated travel time, and provides data to render the initial set of isolines in the geographic database. By way of example, a user interface (UI) 500 in FIG. 5A depicts an initial intermodal route isoline map with a subway station 501 and 5-minute interval isolines 503a, 503b, 503c, and 503d around the subway station 501 that can be reached in 5, 10, 15, 20 minutes from the subway station 501 by the user via, e.g., walking, after riding the subway to the subway station 501. For example, isolines 503a, 503b depict borders to be reached in 5, 10 minutes from the subway station 501, while isolines 503c, 503d depict borders to be reached by walking in 5 minutes from the respective subway stations 505, 507.

In one embodiment, the routing platform 105 renders one or more vehicle representations of one or more shared vehicles (e.g., a car, motorcycle, electric bike, electric scooter, bicycle, etc.) associated with the plurality of combinations in the user interface 500 before, concurrently, or after rendering the isolines 503a, 503b, 503c, and 503d, and receives an interaction for selecting at least one of the one or more vehicles (e.g., e-scooter) via the user interface 500.

In another embodiment, the routing platform 105 selects a subset of the plurality of combinations, e.g., a subway plus an e-scooter. In this example, the isoline is computed based on the subset. The isoline represents a geographic extent that is reachable from the starting location 501 within a designated travel time (e.g., 5, 10, 15, 20 minutes) using an intermodal route that combines at least two of the plurality of modes of transport.

In one embodiment, the routing platform 105 computes another set of isolines based on the selected at least one of the one or more vehicles (e.g., an e-scooter), wherein the another isoline indicates another geographic extent that is reachable using the selected at least one of the one or more vehicles within another designated travel time. The routing platform 105 provides other data to render the another isoline in the geographic database. For example, the routing platform 105 presents one or more available e-scooters in an intermodal route isoline map in UI 520 of FIG. 5B for the user to select an available e-scooter. In another embodiment, the routing platform 105 selects an available e-scooter based on user profile data (e.g., user subscriptions with mobility providers, user preferences, etc.), user context data (e.g., user having no load to carry), etc. In step 405, the routing platform 105 provides data to generate a user interface depicting a representation of the isoline in the intermodal route isoline map.

Upon the selection of an e-scooter located within 10-minute walk from the subway station 501, the routing platform 105 incorporates the outreach of the e-scooter into subway isolines 503b, 503c, etc. as intermodal isolines 523b, 523c, etc. in FIG. 5B. In this example, the user interface renders the subway isolines 503b, 503c, etc. and the intermodal isolines 523b, 523c, etc. differently, e.g., different line styles, weights, patterns, colors, etc.).

In one embodiment, the routing platform 105 presents the furthest intermodal route reachable in 10-minute in UI 520 of FIG. 5B. The furthest intermodal route includes a segment S1 from the subway station 501 to an e-scooter location 521, and a segment S2 from the e-scooter location 521 to a furthest 10-min reachable location 525. To simplify the discussion, FIG. 5B shows travel segments as straight lines instead of real-world road lines on a map. In addition, an intermodal route icon 527 is shown in UI 520 for the furthest intermodal route using a combined graphic symbol depicting a subway and an e-scooter.

In another embodiment, upon an additional selection of a bicycle located next to a subway station 541, the routing platform 105 incorporates the outreach of the bicycle into subway isolines 503b, 503c, etc. as intermodal isolines 543b, 543c, etc. in UI 540 of FIG. 5C. In this example, the user interface renders the subway isolines 503b, 503c, etc., the intermodal isolines 523b, 523c, etc., and the intermodal isolines 543b, 543c, etc. differently, e.g., different line styles, weights, patterns, colors, etc.).

In one embodiment, the routing platform 105 additionally presents the furthest intermodal route reachable in 20-minute in UI 540 of FIG. 5C. The furthest intermodal route includes a segment S3 from the subway station 501 to the subway station 541, and a segment S4 from the subway station 541to a furthest 5-min reachable location 545. In addition, an intermodal route icon 547 is shown in UI 540 for the furthest intermodal route using a combined graphic symbol depicting a subway and a bicycle. FIG. 5C depicts that the furthest intermodal route of the next subway station 541 plus a bicycle reaches further than the furthest intermodal route of the initial subway station 501 plus an e-scooter. In addition, the furthest intermodal route of the next subway station 541 plus a bicycle is cheaper than the furthest intermodal route of the initial subway station 501 plus an e-scooter. In this case, the routing platform 105 recommends the user to take the furthest intermodal route of the next subway station 541 plus a bicycle.

FIGS. 5A-5C present a destination-less scenario, in which a user is more interested in the “reach”, i.e., what are all the places and areas that can be reached within e.g., 15 minutes. In FIGS. 5D-5E, the routing platform 105 selects an intermodal route based on a destination, a cost to the destination, or a combination thereof.

In one embodiment, the routing platform 105 automatically decides the intermodal route for the user based on a cost function including routing cost function parameter such as distance, fuel efficiency, etc. customized for the user. In other embodiments, the routing platform 105 automatically decides the intermodal route based on the cost function, user preferences (e.g., comfort, vehicle models, vehicle seat numbers, cruise control, etc.), and/or user context, etc. For example, such optimum intermodal route may satisfy the requesting user's criteria (such as cost less than $15).

By way of example, upon an indication of a destination 561 and a selection of a bicycle 565, the routing platform 105 incorporates the outreach of the bicycle into subway isolines 503c, etc. as intermodal isolines 563c, etc. in UI 560 FIG. 5D. In this example, the user interface renders the subway isolines 503b, 503c, etc., the intermodal isolines 523b, 523c, etc., the intermodal isolines 543b, 543c, etc., and the intermodal isolines 563c, etc. differently, e.g., different line styles, weights, patterns, colors, etc.).

In one embodiment, the routing platform 105 presents the furthest intermodal route reachable in 15-minute in UI 560 of FIG. 5D. The furthest intermodal route includes a segment S5 from the subway station 501 to the location 565, and a segment S6 from the location 565 to the destination 561. In addition, an intermodal route icon 567 is shown in UI 560 for the furthest intermodal route using a combined graphic symbol depicting a subway and a bicycle.

In another example, upon an additional selection of another bicycle parking next to a subway station 581, the routing platform 105 incorporates the outreach of the bicycle into subway isolines 503c, etc. as intermodal isolines 583c, etc. in UI 580 FIG. 5E. In this example, the user interface renders the subway isolines 503b, 503c, etc., the intermodal isolines 523b, 523c, etc., the intermodal isolines 543b, 543c, etc., the intermodal isolines 563c, etc., and the intermodal isolines 583c, etc. differently, e.g., different line styles, weights, patterns, colors, etc.).

In one embodiment, the routing platform 105 presents the furthest intermodal route reachable in 20-minute in UI 580 of FIG. 5E. The furthest intermodal route includes a segment S7 from the subway station 501 to the subway station 581, and a segment S8 from the subway station 581 to the destination 561. In addition, an intermodal route icon 587 is shown in UI 560 for the furthest intermodal route using a combined graphic symbol depicting a subway and a bicycle. FIG. 5E depicts that the furthest intermodal route of the next subway station 581 plus a bicycle reaches the same destination as the furthest intermodal route of the initial subway station 501 plus an e-scooter, yet traveling longer distances by subway and by bicycle (i.e., costing more). In this case, the routing platform 105 recommends the user to take the furthest intermodal route via the location 561 plus a bicycle.

In one embodiment, the routing platform 105 determines the destination based on a user input (e.g., text, audio, video, etc.). In another embodiment, the routing platform 105 determines the destination based on a mobility graph (e.g., learning user behaviors, the user's familiarity index with the area, etc.) associated with a user, and computes the intermodal route with respect to the at least one destination. In this example, the routing platform 105 generates a representation of the at least two of the plurality of modes of transports used in the intermodal route to reach the at least one destination, and renders the representation of the at least two of the plurality of modes of transports in the user interface in association with the isoline, the at least one destination, or a combination thereof.

As mentioned previously, the high number of combinations between modes of transport makes it very expensive to compute all available combinations. One way to make this less computing expensive is to compute the probability of vehicles to be available at some transport hubs/stations (or more generally locations, such as points of interest) and use the data for the intermodal isoline computation. In one embodiment, the probability is computed based on historical availability data, which allows for creating look-up tables with an expected availability for a given region. Such lookup tables can be done locally, instead of querying real-time data from the transport providers. In another embodiment, the probability is computed based on relatively recently retrieved real-time data, without querying real-time data from the transport providers.

In one embodiment, the routing platform 105 computes a probability that at least one of the plurality of modes of transport will be available at a transport hub, such as the subway station 501, on the intermodal route based on the real-time availability data. In this example, the isoline is further based on the probability.

In one embodiment, the routing platform 105 calculates a probability at least one of the plurality of modes of transport will be available at a transport hub based on machine learning and factors such as the transport hub location, the modes of transport time table, the modes of transport trajectory data, etc. For example, the routing platform 105 calculates a probability D which a joint probability distribution or matrix for parameters X, Y, Z . . . that gives the probability that each of factors X, Y, Z . . . falls in any particular range or discrete set of values specified for that variable. For example, Xis a vehicle's profile parameter (e.g., three of four times that the vehicle parks at the transport hub and one out of four times that the vehicle parks 0.5 mile from the transport hub), and Y is a is a transport timing parameter (e.g., on time vs. delay). To simplify the discussion, only X and Y are used to generate a joint probability distribution or matrix as Table 1 as follows:

TABLE 1

| | X = transport hub | X = 0.5 m away | P(Y) |
|---|---|---|---|
| Y = on time | (1)(¾) = ¾ | (1)(¼) = 0 | ¾ + 0 = ¾ |
| Y = delay | (0)(¾) = ¼ | (0)(¼) = 0 | ¼ + 0 = ¼ |
| P(X) | ¾ + ¼ = 1 | 0 + 0 = 0 | |

By way of example, when the routing platform 105 determines the probability that the vehicle will reach the transport hub within 200 meters meets or exceeds a threshold value (e.g., 85%), the routing platform 105 presents the vehicle and the relevant intermodal mode to the user.

In another embodiment, the routing platform 105 continues monitoring the vehicle location and the user location as well as calculating the probability that the user and the vehicle will reach the transport hub within a riding time frame of the relevant intermodal mode.

In another embodiment, the routing platform 105 computes a probability that at least one of the plurality of modes of transport will be available at time when the at least one of the plurality of modes of transport is predicted to be used on the intermodal route based on the real-time availability data. In this example, the isoline is further based on the probability.

In one embodiment, the routing platform 105 determines an operating area and a plurality of exit points on a border of the operating area, wherein the operating area is associated with a mobility provider associated with at least one of the plurality of modes of transport. In this example, the user interface renders the isoline with respect to the plurality of exit points. In one embodiment, the routing platform 105 determines the relevant exit roads intersecting with the operating areas borders as exit points, based on functional classes, public transport stations, and other relevant parameters.

In other embodiments, the routing platform 105 computes static and/or dynamic isolines at the pre-determined points near the boundaries of the operating area, and visualizes those aggregated isolines around the operating areas statically and/or dynamically (i.e., in real-time based on trajectory data and/or availability data.

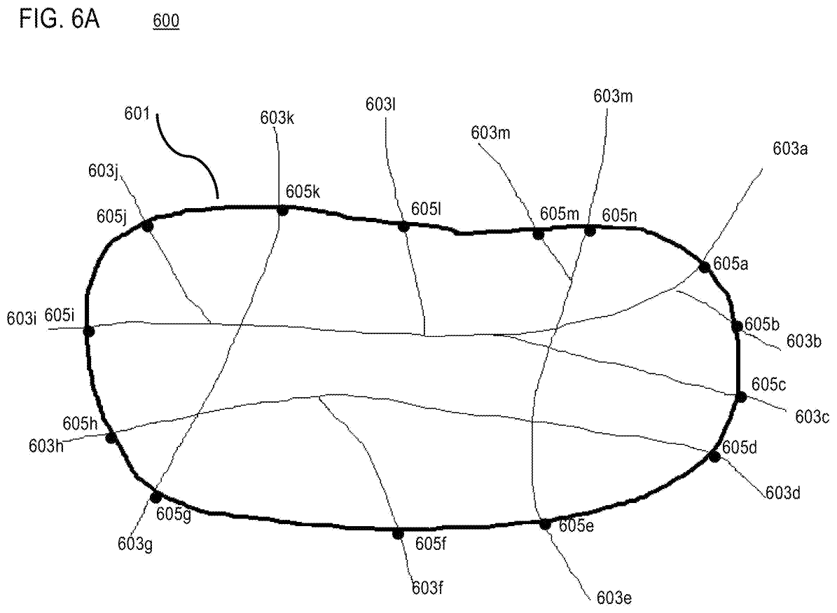

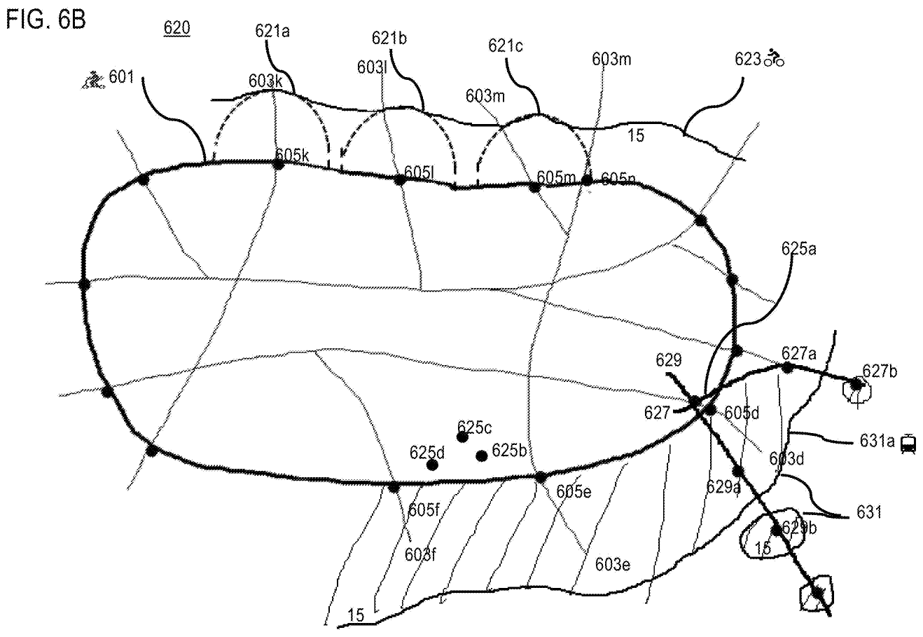

FIGS. 6A-6B are diagrams of user interfaces used in the processes for providing an mobility provider service area isoline map, according to various embodiments. More specifically, FIGS. 6A-6B illustrate user interfaces that can be used in real-time by UEs 101 participating in a routing service provided by the system 100 to compute aggregated isolines of mobility operator's service areas. By incorporating the reachability of vehicles that are not operated by the mobility provider, the routing platform 105 shows a larger geographical reach for the mobility operator.

In UI 600 of FIG. 6A, the routing platform 105 visualizes a mobility provider's service area 601 of e-scooters overlaying a road network consisting of roads 603a-603m and crossing the roads at exit points 605a-605m.

To conserve computation resources and/or avoid cluttering the user interface, the routing platform 105 visualizes virtual extensions of a mobility provider's service areas by computing isolines only at selected exit points of those service areas (e.g., highway rest areas, transport hubs, other points of interest, etc.), which are reachable by users within a given amount of time (e.g., 10 min) from the exit points, using one or more modes of transport that are not operated by the mobility provider. For example, in UI 620 of FIG. 6B, the routing platform 105 visualizes virtual extensions of the mobility provider's service area by computing isolines at the exit points 605a-605m of the service area, using bicycles or subways that are not operated by the mobility provider. In FIG. 6B, the routing platform 105 keeps the outside contour 623 of the aggregated bicycle isolines 621a, 621b, 621c, etc., to reflect the new virtual service area, e.g., within 15-min from the border of service area 601.

In FIG. 6B, there are four subway stations 625a, 625b, 625c, 625d, and each of which is connected to a plurality of subway stations. For example, station 625a has two subway lines 627, 629 joined there at and with stations 627a-627b, and stations 629a-629c extending outwards. By analogy, the routing platform 105 keeps the outside contours 631 of the aggregated subway station isolines to reflect the new virtual service area, e.g., within 15-min from the border of service area 601.

In another example, the system 100 clusters the exit points in a meaningful way in order to further reduce the computation needs.

By showing users all the areas which are reachable within a reasonable amount of time, starting at the borders of the operating zone, the routing platform 105 shows users that those areas are actually not that far from the service area and reachable within reasonable time using the shared vehicles in combination with another mode of transport makes sense.

In one embodiment, whenever the mobility operator updates the service areas, such as changing general service coverage expansions plans (starting small and slowly expanding service coverage in a city), considering specific events that benefit from mobility services, excluding some areas from services where there are problems, increasing services where there is more demand created by users or created by the removal of some previously existing operators, etc., the routing platform 105 periodically, or in real-time, or in substantially real-time updates the map of the mobility provider's service areas. In another embodiment, the routing platform 105 considers such changes/extensions and monitors which users are within a predetermined minute threshold from those service areas, and presents the updated service area map to new users within the threshold coverage.

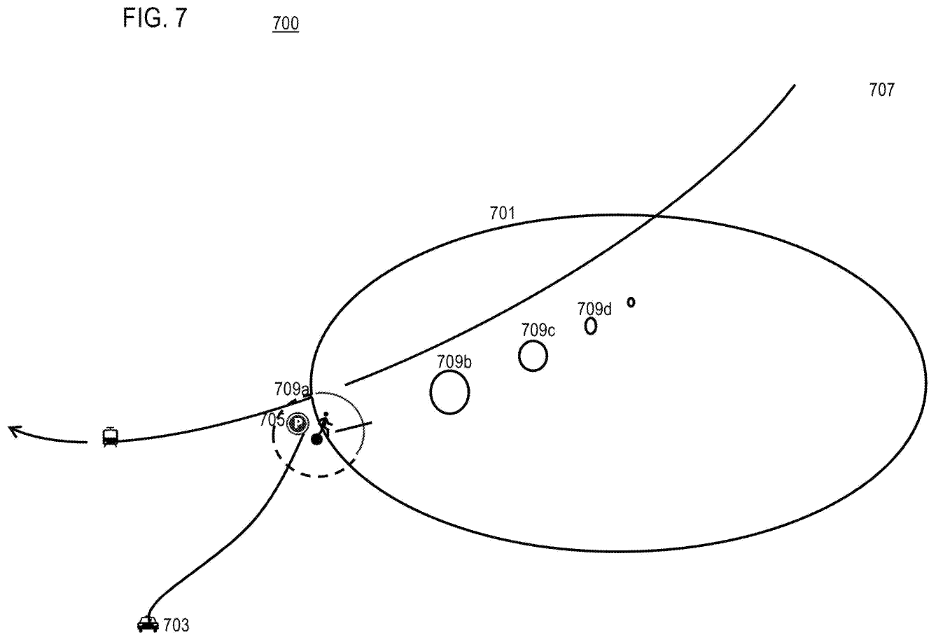

In another embodiment, the routing platform 105 visualizes virtual extensions of a mobility provider's service areas considering one or more traffic restricted areas/zones where some or all types of vehicles are forbidden at certain times, or on certain days or dates, or a combination thereof. FIG. 7 is a diagram of a user interface used in the processes for providing an intermodal route isoline map with a restricted area, according to one embodiment. For examples, there are big road-closing events, such as constructions, marathons, parades, protests, weekend markets, severe weather conditions, traffic accidents, geofencing areas, etc. In UI 700 of FIG. 7, a restricted area 701 (e.g., electric vehicle only areas/“Green zone” areas, diesel exclusion areas) leads a user to drive a shared vehicle 703 to a parking area 705, then takes a subway 707 to walk to subway service areas 709a, 709b, 709c, 709d, etc.

The computation of the different embodiments mentioned previously can be done partially or totally on servers/cloud, or at the edge of the network in order to balance the network load/cellular usage.

The above-discussed embodiments support determination of an intermodal route isoline map in a destination-less mode or with respect to a destination, considering the most efficient and cost effective combination of all possible modes of transport (including walking, public transport, shared vehicles, etc.). When the user indicates a destination, the above-discussed embodiments can be fine-tune the computing and rendering with this destination and minimize visual clutter to the destination.

The above-discussed embodiments allow users to visualize the intermodal route isoline map thereby considering the most efficient and cost effective intermodal route to optimize travel cost/distance/time.

The above-discussed embodiments provide users more advanced and reliable information about the places that can be reached within a given amount of time, which were likely not known to the users by previously existing methods

The above-discussed embodiments leveraging the most up-to-date information about available vehicles to offer the best intermodal combination.

The above-discussed embodiments real-time monitor the travel status of the user and the vehicle and adjust the intermodal route accordingly (e.g., in case of traffic delays).

The above-discussed embodiments increase usage of the vehicles by expanding a mobility provider's service areas in a map, and updating the map with new coverages to attract new users.

The above-discussed embodiments combine different technologies (sensors, probability computation, multimodal routing, intermodal routing, mobility graph, isoline routing, real-time modeling of vehicles' availability, machine learning, etc.) to provide a platform for mobility providers to share their data and get insights of intermodal routes via combining many types of data sets, thereby determining candidate riding points, develop multi and intermodal transport solutions, and an intermodal route isoline map.

The processes described herein for providing an intermodal route isoline map may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

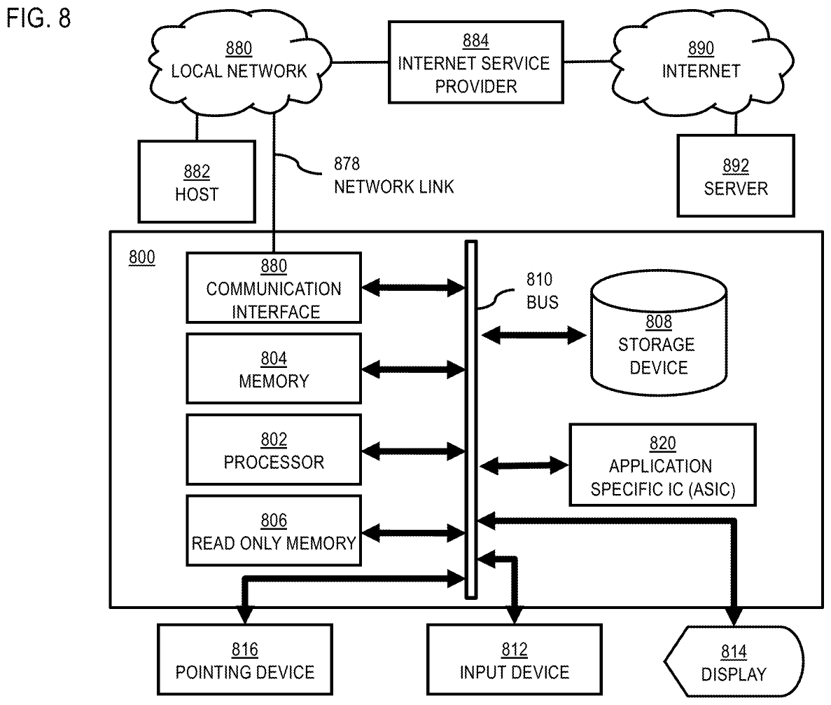

FIG. 8 illustrates a computer system 800 upon which an embodiment of the invention may be implemented. Although computer system 800 is depicted with respect to a particular device or equipment, it is contemplated that other devices or equipments (e.g., network elements, servers, etc.) within FIG. 8 can deploy the illustrated hardware and components of system 800. Computer system 800 is programmed (e.g., via computer program code or instructions) to provide shared vehicle availability detection based on vehicle trajectory information as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing an intermodal route isoline map.

A bus 810 includes one or more parallel conductors of information so that information is transferred quickly among devices coupled to the bus 810. 0n e or more processors 802 for processing information are coupled with the bus 810.

A processor (or multiple processors) 802 performs a set of operations on information as specified by computer program code related to providing an intermodal route isoline map. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for providing an intermodal route isoline map. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing an intermodal route isoline map, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 880 coupled to bus 810. Communication interface 880 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 880 may be a parallel port or a serial port or a universal serial bus (USB) port on a personal computer. In some embodiments, communications interface 880 is an integrated services digital network (ISDN) card or a digital subscriber line (DSL) card or a telephone modem that provides an information communication connection to a corresponding type of telephone line. In some embodiments, a communication interface 880 is a cable modem that converts signals on bus 810 into signals for a communication connection over a coaxial cable or into optical signals for a communication connection over a fiber optic cable. As another example, communications interface 880 may be a local area network (LAN) card to provide a data communication connection to a compatible LAN, such as Ethernet. Wireless links may also be implemented. For wireless links, the communications interface 880 sends or receives or both sends and receives electrical, acoustic or electromagnetic signals, including infrared and optical signals, that carry information streams, such as digital data. For example, in wireless devices, such as mobile computers like vehicle infotainment system, the communications interface 880 includes a radio band electromagnetic transmitter and receiver called a radio transceiver. In certain embodiments, the communications interface 880 enables connection to the communication network 107 for providing an intermodal route isoline map to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 880, carry information to and from computer system 800. Computer system 800 can send and receive information, including program code, through the networks 880, 890 among others, through network link 878 and communications interface 880. In an example using the Internet 890, a server host 892 transmits program code for a particular application, requested by a message sent from computer 800, through Internet 890, ISP equipment 884, local network 880 and communications interface 880. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 880 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

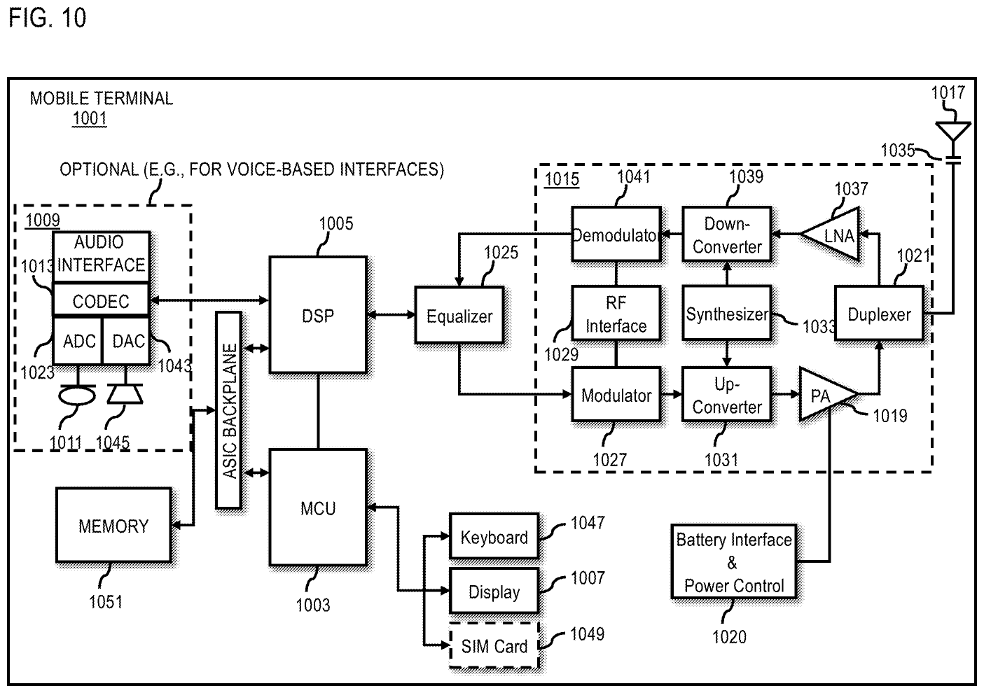

FIG. 9 illustrates a chip set or chip 900 upon which an embodiment of the invention may be implemented. Chip set 900 is programmed to provide shared vehicle availability detection based on vehicle trajectory information as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing an intermodal route isoline map.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide shared vehicle availability detection based on vehicle trajectory information. The memory 905 also stores the data associated with or generated by the execution of the inventive steps.

FIG. 10 is a diagram of exemplary components of a mobile terminal (e.g., mobile computers such as vehicle infotainment system, vehicle embedded system, smartphones, etc.) for communications, which is capable of operating in the system of FIG. 1, according to one embodiment. In some embodiments, mobile terminal 1001, or a portion thereof, constitutes a means for performing one or more steps of providing an intermodal route isoline map. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile computer or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile computer or a similar integrated circuit in network device (e.g., a cellular network device or data other network devices).

Pertinent internal components of the mobile terminal include a Main Control Unit (MCU) 1003, a Digital Signal Processor (DSP) 1005, and a receiver/transmitter unit. In one embodiment, wherein voice-based interaction and/or communications are supported at the mobile terminal, the mobile terminal may also include a microphone gain control unit and a speaker gain control unit. A main display unit 1007 provides a display to the user in support of various applications and mobile terminal functions that perform or support the steps of providing an intermodal route isoline map. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. In embodiments supporting voice-based interactions and/or communications, an audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station (e.g., data and/or voice communications), which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, data to support providing an intermodal route isoline map is formatted into network packets (e.g., Internet Protocol (IP) packets) for transmission using one or more network transmission protocol (e.g., a cellular network transmission protocol described in more detail below). In one embodiment, the network packets include control information and payload data, with the control information specifying originating/destination network addresses, error control signals, signals for reconstructing the user data from the packets, and/or other related information. In embodiments supporting voice-based interaction and/or communications, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech recognition, speech encoding, channel encoding, encrypting, and interleaving.

In one embodiment, the processed network packets and/or voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission through the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The local base station or similar component then forwards data or network packets to a gateway server (e.g., a gateway to the Internet) for connectivity to network components used for providing shared vehicle availability detection. In embodiments supporting voice-based interactions and/or communications, voice signals may be forwarded from the local base station to a remote terminal which may be another mobile computer, cellular telephone, and/or any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide shared vehicle availability detection based on vehicle trajectory information. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details (e.g., data and/or voice subscriptions), and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for providing an intermodal route isoline map, comprising:
determining real-time availability data of a plurality of modes of transport within a geographic area;
computing an isoline based on the real-time availability data, wherein the isoline represents a geographic extent that is reachable from a starting location within a designated travel time using an intermodal route that combines at least two of the plurality of modes of transport; and
providing data to generate a user interface depicting a representation of the isoline in the intermodal route isoline map.

2. The method of claim 1, further comprising:
computing a probability that at least one of the plurality of modes of transport will be available at time when the at least one of the plurality of modes of transport is predicted to be used on the intermodal route based on the real-time availability data,
wherein the isoline is further based on the probability.

3. The method of claim 1, further comprising:
computing a probability that at least one of the plurality of modes of transport will be available at a transport hub on the intermodal route based on the real-time availability data,
wherein the isoline is further based on the probability.

4. The method of claim 1, wherein the real-time availability data includes at least one of: an availability of a shared vehicle, an operating area of a shared vehicle, public transport information, a mobility history of a user, user preference information, user registration information with a mobility service, contextual information, a user destination, or a combination thereof.

5. The method of claim 1, further comprising:
computing a plurality of combinations of the at least two of the plurality of modes of transport; and
selecting a subset of the plurality of combinations,
wherein the isolines is computed based on the subset.

6. The method of claim 5, wherein the selecting of the subset of the plurality of combinations comprises:
rendering one or more vehicle representations of one or more shared vehicles associated with the plurality of combinations in the user interface prior to rendering the isoline; and
receiving an interaction for selecting at least one of the one or more vehicles via the user interface,
wherein the isoline is computed based on the selected at least one of the one or more vehicles.

7. The method of claim 5, further comprising:
computing another isoline based on the selected at least one of the one or more vehicles, wherein the another isoline indicates another geographic extent that is reachable using the selected at least one of the one or more vehicles within another designated travel time; and
providing other data to render the another isoline in the geographic database.

8. The method of claim 1, further comprising:
determining at least one destination based on a mobility graph associated with a user,
wherein the intermodal route is computed with respect to the at least one destination.

9. The method of claim 8, further comprising:
generating a representation of the at least two of the plurality of modes of transports used in the intermodal route to reach the at least one destination; and
rendering the representation of the at least two of the plurality of modes of transports in the user interface in association with the isoline, the at least one destination, or a combination thereof.

10. The method of claim 1, further comprising:
computing another isoline to represent another geographic extent that is reachable from the starting location with the designated travel time via using an initial one of the plurality of modes of transport,
wherein the user interface renders the isoline and the another isoline differently.

11. The method of claim 1, further comprising:
determining an operating area and a plurality of exit points on a border of the operating area, wherein the operating area is associated with a mobility provider associated with at least one of the plurality of modes of transport,
wherein the isoline is rendered in the user interface with respect to the plurality of exit points.

12. An apparatus comprising:
at least one processor; and
at least one memory including computer program code for one or more programs,
the at least one memory and the computer program code configured to, with the at least one processor, cause the apparatus to perform at least the following,
determine real-time availability data of a plurality of modes of transport within a geographic area;
compute an isoline based on the real-time availability data, wherein the isoline represents a geographic extent that is reachable from a starting location within a designated travel time using an intermodal route that combines at least two of the plurality of modes of transport; and
provide data to generate a user interface depicting a representation of the isoline in the intermodal route isoline map.

13. An apparatus of claim 12, wherein the apparatus is further caused to:
compute a probability that at least one of the plurality of modes of transport will be available at time when the at least one of the plurality of modes of transport is predicted to be used on the intermodal route based on the real-time availability data,
wherein the isoline is further based on the probability.

14. An apparatus of claim 12, wherein the apparatus is further caused to:
compute a probability that at least one of the plurality of modes of transport will be available at a transport hub on the intermodal route based on the real-time availability data,
wherein the isoline is further based on the probability.

15. An apparatus of claim 12, wherein the real-time availability data includes at least one of:
an availability of a shared vehicle, an operating area of a shared vehicle, public transport information, a mobility history of a user, user preference information, user registration information with a mobility service, contextual information, a user destination, or a combination thereof.

16. An apparatus of claim 12, wherein the apparatus is further caused to:
compute a plurality of combinations of the at least two of the plurality of modes of transport; and
select a subset of the plurality of combinations,
wherein the isolines is computed based on the subset.

17. An apparatus of claim 16, wherein the apparatus is further caused to select the subset of the plurality of combinations by:
rendering one or more vehicle representations of one or more shared vehicles associated with the plurality of combinations in the user interface prior to rendering the isoline; and
receiving an interaction for selecting at least one of the one or more vehicles via the user interface,
wherein the isoline is computed based on the selected at least one of the one or more vehicles.

18. A non-transitory computer-readable storage medium carrying one or more sequences of one or more instructions which, when executed by one or more processors, cause an apparatus to at least perform the following steps:
determining real-time availability data of a plurality of modes of transport within a geographic area;
computing an isoline based on the real-time availability data, wherein the isoline represents a geographic extent that is reachable from a starting location within a designated travel time using an intermodal route that combines at least two of the plurality of modes of transport; and
providing data to generate a user interface depicting a representation of the isoline in the intermodal route isoline map.

19. A non-transitory computer-readable storage medium of claim 18, wherein the apparatus is further caused to perform:
computing a probability that at least one of the plurality of modes of transport will be available at time when the at least one of the plurality of modes of transport is predicted to be used on the intermodal route based on the real-time availability data,
wherein the isoline is further based on the probability.

20. A non-transitory computer-readable storage medium of claim 18, wherein the apparatus is further caused to perform:
computing a probability that at least one of the plurality of modes of transport will be available at a transport hub on the intermodal route based on the real-time availability data,
wherein the isoline is further based on the probability.
